(19) United States
(12) Patent Application Publication
(10) Pub. No.: US 2013/0194078 A1
(43) Pub. Date: Aug. 1, 2013

(54) MOBILE READING DEVICE, AND METHOD FOR LOCATING AN OBJECT THAT IS MARKED WITH ACTIVE TRANSPONDER

(71) Applicants: Andreas Bohnenberger, Grunbach (DE); Daniel Evers, Otterfing (DE); Martin Glänzer, Munchen (DE); Ulrike Heim, Munchen (DE); Fabian Kurz, Munchen (DE)

(72) Inventors: Andreas Bohnenberger, Grunbach (DE); Daniel Evers, Otterfing (DE); Martin Glänzer, Munchen (DE); Ulrike Heim, Munchen (DE); Fabian Kurz, Munchen (DE)

(21) Appl. No.: 13/577,176

(22) PCT Filed: Dec. 7, 2010
(86) PCT No.: PCT/EP2010/069025

§ 371 Date: Oct. 26, 2012

(30) Foreign Application Priority Data
Feb. 5, 2010 (DE) 10 2010 006 982.5

(51) Int. Cl. G06K 7/00

(52) U.S. Cl. CPC G06K 7/0008
USPC 340/10.6

(57) ABSTRACT

An antenna device in a reading device has a main radiation direction and receives a signal transmitted by a transponder. An electronic assembly calculates a direction from the reading device to the transponder using the received signal. An orientation detector in the reading device, for example an electronic compass, detects an absolute orientation of the reading device with respect to an exterior region. While the main radiation direction of the antenna is pivoted in the region and the signal strength is measured, the orientation in the region is simultaneously detected. A correlation of the orientation that is detected at a point in time to the signal strength that is measured at the same point in time allows determination of the direction to the transponder because it can be assumed that the signal has a maximum when the main radiation direction points in the direction of the transponder.

### CROSS REFERENCE TO RELATED APPLICATIONS

This application is the U.S. national stage of International Application No. PCT/EP2010/069025, filed Dec. 7, 2010 and claims the benefit thereof. The International Application claims the benefit of German Application No. 10 2010 006 982.5 filed on Feb. 5, 2010, both applications are incorporated by reference herein in their entirety.

### BACKGROUND

Described below is a mobile direction-finding device for locating an object that is marked with an active transponder.

Locating an object again, for example in large industrial warehouses, represents a significant cost factor as the search for the object is often extremely time-consuming. The use of RFID technology (“radio frequency identification” or in other words identification with the aid of electromagnetic waves) known per se can accelerate location. A corresponding RFID system usually has at least one transponder and one reading device. The transponder, which can also be described as a “tag”, is fastened to an object which, for example, is stored temporarily in a warehouse and is to be located later on. In order to find the object or the transponder again, the reading device is used. This transmits an RF request signal which is received, modulated and either reflected or actively transmitted again by the transponder, modulation taking place in accordance with the data which is to be transmitted to the reading device. As a rule, modulation is selected such that it is at least appropriate for identifying the transponder clearly. If the transponder has an additional sensor, for example, then modulation can also take place as a function of the measured values recorded by the sensor. In addition or alternatively, any data can also be stored in a corresponding storage device of the transponder, for example information about the object to which the transponder is fastened. Accordingly, this data would also be included in the modulation.

In particular with the active RFID method, so-called active transponders are used for the aforementioned purpose, in which the signal transmitted by the reading device is not reflected but actively transmitted after modulation. As a result, a greater range can be obtained, although at the expense of more costly construction of the transponder. For example, in this case it is necessary to provide a power supply. Here too different possibilities are known, from battery or storage battery operation through to energy-self-sufficient transponders which draw the power required for operation from the environment of the transponder.

The sought object marked with an active transponder must always be within reading range of the reading device in order to be able to be found and identified. Furthermore, there must not be any obstacles between the reading device and the transponder which shield the transponder signal.

Depending on the positioning accuracy required, variously priced positioning methods can be employed or run-time based or field-strength based positioning combined with corresponding algorithms. Accuracy of 1-5 m is attainable with such methods. However, what all these methods have in common is that for their realization they require a comparatively complex infrastructure of positioning stations (=reading devices), which if need be must even be expensively positioned, calibrated or possibly synchronized. For this reason, such positioning with high accuracy is particularly unsuitable for dynamic storage as, for example, under certain circumstances there is no power supply available (e.g. a building site in the open air) and/or as the permanent establishment of infrastructure can often not be guaranteed. In addition, a dense infrastructure, as is required for precise positioning, is so cost-intensive that the economic benefit of locating objects rapidly becomes relative or is eliminated.

In principle, it is also possible to locate the active transponder solely on the basis of a field-strength-based measurement as it is assumed that the transponder must be in the direction in which the strongest signal is measured. For this, the field strength is measured with the reading device while it is pivoted in the region. The reading device or the antenna is pivoted for at least as long as it takes to detect a maximum signal level. The transponder sought must then be in the corresponding direction. However, this method requires trained personnel.

### SUMMARY

The problem of expensive and cost-intensive location infrastructure is solved by the location function being completely integrated into a single mobile reading device which is in a position to indicate the direction to the sought object marked with a transponder without the actual position of the transponder and/or the reading device needing to be known itself. A warehouseman can thus navigate to the respective active transponder and hence to the sought object with the aid of this reading device.

A mobile reading device has:
an antenna device for receiving a signal S that can be transmitted by a transponder, the antenna device having a main radiation direction,
an electronic assembly for calculating a direction from the reading device to the transponder using the received signal S,
a display device on which the calculated direction can be displayed,
wherein
the reading device has an orientation detector with which an orientation or a change in orientation of the reading device with regard to a coordinate system ΔR assigned to an exterior region can be detected.

Advantageously the electronic module is designed to calculate the direction to the transponder to be displayed on the display device from the signal strength of the signal received with the antenna device and from the orientation R or change of orientation ΔR of the reading device detected at the same time as the signal strength.

The orientation detector is in particular designed to indicate an absolute orientation R in the exterior region. In addition, an incremental sensor can be provided which quantitatively detects a change in the orientation of the reading device in the exterior region.

Alternatively, the orientation detector is designed to indicate a relative orientation in the exterior region with regard to a particular starting point of the reading device, in particular a change in orientation ΔR with regard to the starting point.

The main radiation direction of the antenna device can be pivoted in relation to the reading device. In particular, the antenna device itself can be pivoted in relation to the reading device. Alternatively, the main radiation direction of the antenna device can be pivoted electronically.

A method for detecting the direction of a mobile reading device to a transponder, wherein the reading device has an antenna device with a main radiation direction, features:
the antenna device receives a signal from the transponder,
the main radiation direction is pivoted with regard to an exterior region during reception, wherein during pivoting the strength of the received signal is measured at the same time as an orientation or a change in orientation of the reading device with regard to the exterior region is detected,
these data sets including the signal strength measured during pivoting and the orientation or change in orientation detected at the same time are correlated to each other, wherein the orientation or change in orientation which was detected at the maximum signal strength measured is identified as the direction sought to the transponder.

The main radiation direction is pivoted by
moving the reading device relative to the exterior region,
moving the antenna device relative to the reading device or
using an electronic pivot.

The transponder is a passive transponder and the signal S transmitted by the transponder is a signal first transmitted by the reading device and reflected on the transponder.

Alternatively, the transponder is an active transponder which actively transmits the signal.

An absolute orientation may be detected with regard to the exterior region and in addition, in particular after the direction to the transponder has been determined, changes in the orientation of the reading device are detected quantitatively, these changes being used to improve or correct the result of the determination of direction.

With the aid of the mobile reading device and the method, a warehouseman, for example, can navigate to the target by an automated bearing of an active transponder. This can be supported by a corresponding display on the reading device. The reading device completely replaces any location infrastructure such as location base stations or GPS satellites. Even without this infrastructure, objects can be located rapidly. All objects within range, for example marked by active RFID tags, can be used as a navigation target. By using an electronic compass in the reading device, the indicated bearing direction is correct regardless of the orientation of the warehouseman or the reading device in the region. If the warehouseman follows the direction data of the reading device, it leads him to the target by the direct route.

### BRIEF DESCRIPTION OF THE DRAWINGS

These and other aspects and advantages, features and details will become more apparent and more readily appreciated from the following description of the exemplary embodiment described below as well as from the accompanying drawings of which:

FIG. 1 is a schematic plan view of a warehouse,

FIG. 2 is a block diagram of a reading device.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

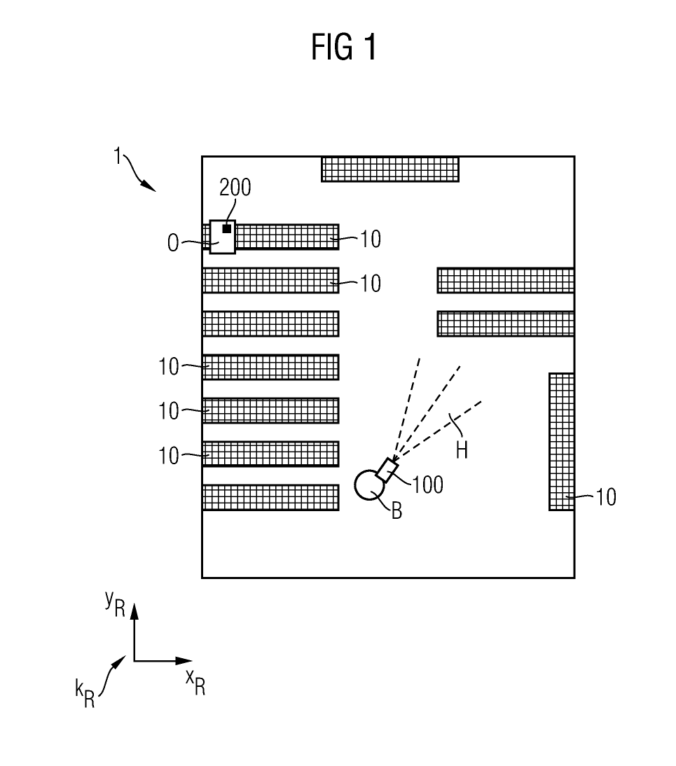

FIG. 1 shows a warehouse 1 in which a user B, for example a warehouseman, is looking with the aid of a reading device 100 for an object O, which is on a shelf 10 of the warehouse and is marked with an active transponder 200. The warehouse 1 is assigned a coordinate system K_{R}. To locate the transponder 200, the reading device 100, or more generally a main radiation direction H of an antenna (in FIG. 1 only indicated) of the reading device 100, is pivoted in the region.

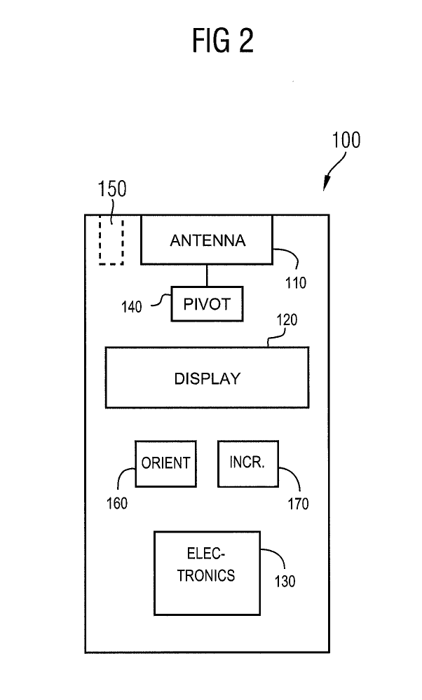

A commercially available reading device 100 typically has at least the following components (cf. FIG. 2):
an antenna device 110, which receives the signal S transmitted by the active transponder 200,
a display device 120, on which the detected direction of the reading device 100 to the transponder 200 is displayed, and
an electronic assembly 130, in which at least all the processes for data processing including the calculation of the direction to the transponder 200 using the received transponder signal S and the control of the display device 120 and possibly the antenna device 110 operate.

To determine the direction from the reading device 100 to the transponder 200 various approaches are possible:
a) The reading device 100 is pivoted in various directions, while during pivoting the transponder signal S is measured. The term “pivot” includes merely rotating to and fro about the vertical as well as a complete 360° rotation of the main radiation direction about the vertical. An evaluation of the signal strength of the received signal S as a function of the pivot direction produces the sought direction in which the transponder 200 is located, the direction in which the maximum signal strength is measured corresponding to the direction sought. Ideally, the antenna device 110 is a beam antenna 110, the beam characteristic of which has a maximum which corresponds to a main beam direction of the antenna device 110 or the beam antenna 110.
b) To simplify handling of the reading device 100, the antenna device 110 of the reading device 100 can also be designed as a controllable beam antenna 110. The main radiation direction of such a beam antenna 110 can be designed to rotate or pivot relative to the reading device 100, in order to be able to omit a manual pivot of the antenna device 110 or the reading device 100.

Such a pivot can be realized by an internal mechanical pivoting device 140, with which the beam antenna 110 itself is swiveled in relation to the reading device 100, and/or by an electric phase and amplitude control of a multi-element beam antenna 110, as for example in a so-called “phased array antenna”. The latter option can be described as electronic pivoting of the main radiation direction.

Such a multi-element beam antenna 110 has at least two individual antennas (not shown). The control of the multi-element beam antenna and/or the swivel mechanism would take place via the electronic module 130.
a) Alternatively, an SAR algorithm (“synthetic aperture radar) can be used. Here too a pivot is performed and the signal strength measured at the same time. In the case of the SAR algorithm it is necessary to know the course of the pivot very precisely with regard to speed and direction, i.e. the reading device 100 must have another corresponding sensor 150. From the data recorded in this way, the direction in which the transponder is located can be reconstructed.

What approaches a) and b) have in common is that the antenna device 110 must be designed as a beam antenna, the main radiation direction of which is pivoted mechanically or electronically. At the same time the dependence of the signal strength on the current direction is measured. In addition to the signal strength of the incoming transponder signal S as a function of the current orientation of the main radiation direction, a phase measurement also permits conclusions to be drawn about the direction to the transponder 200. If the antenna device 110, for example, has two (or more) individual antennas which receive the transponder signal S, then both the phases of the signals received on the individual antennas are dependent on the direction to the transponder 200: the phase difference is zero if the distances of the two antennas to the transponder are equal. This applies to a uniqueness range of 2π. If the antenna array was to be rotated, the phase relationship would also change, the change depending on the wavelength of the signal and the antenna array. Therefore, the direction can be determined by comparing the phases on the individual antennas. Naturally, the phase measurement method can be combined with the measurement of the signal strength to increase the accuracy of direction determination.

With the known methods according to a) and b), the user B watches a display of the signal strength received on the reading device during pivoting and thus establishes the approximate direction in which the transponder is positioned. However, this method is imprecise and presupposes a certain amount of dexterity or experience when handling the reading device.

In approach c), in contrast to a) and b), no beam antenna is required, i.e. the antenna device 110 is less complex here. On the other hand, in approach c) higher processing power or signal processing is required in the electronic assembly 130.

In addition to the aforementioned typical components, the reading device 100 has an orientation device 160 which serves to simplify the establishment of the direction to the transponder 200.

In a first embodiment, the orientation detector 160 permits absolute determination of the orientation of the reading device 100 in the region. The orientation detector 160 can, for example, be designed as an electronic compass 160. The compass 160 is integrated into the reading device 100 and connected to the electronic assembly 130. While the main radiation direction of the antenna device 110, for example, as explained in connection with methods a) or b), is pivoted in the region and in the process the signal strength received from the transponder 200 is measured, at the same time the orientation R of the reading device 100 is detected in the region using the compass. Both these data sets are supplied to the electronic assembly 130, where they are compared to each other or are correlated to each other. This comparison can, for example, be the signal strength S(t1) measured at a point in time t1 being correlated to the orientation R(t1) detected at the same point in time t1. It is thus possible to automatically establish the direction in which the greatest field strength was measured. As it is to be assumed that the signal received has a maximum level if the main radiation direction is pointing in the direction of the transponder, the direction to the transponder can be detected in this way.

Alternatively, to use the electronic compass with which a determination of the absolute orientation of the reading device in the region is possible, an orientation detector 160 can be used in a second embodiment, which only permits the determination of a relative orientation or the determination of a change in orientation. This relative orientation relates to a certain initial situation of the reading device. The initial situation can, for example, be the orientation of the reading device at the time when the reading device is switched on or at the time when a search mode is activated, inter alia. For example, a switch (not shown) could be provided on the reading device upon the activation of which the initial situation is established as the current orientation of the reading device.

Such an orientation detector 160 to detect a relative orientation in relation to an initial situation can be an incremental sensor such as, for example, a gyro 160.

In the second embodiment, the orientation detector 160 of the reading device 100 therefore does not permit any absolute determination of the orientation but only the detection of a change in orientation. However, this is completely adequate for the purpose of determining the direction to the transponder 200. In the second embodiment as well, the main radiation direction of the antenna device 110 of the reading device 100 is pivoted in the region and the signal strength received from the transponder 200 measured in the process. At the same time, the change in orientation R of the reading device 100 in the region is detected with the gyro 160. Both these data sets are supplied to the electronic assembly 130, where they are compared with each another.

What both embodiments have in common is that it is possible to automatically display the direction in which the transponder is located on the basis of the simultaneous detection of the signal strength and the absolute or relative orientation. The determination of the direction is thus greatly simplified as the user of the reading device no longer needs to manually search for the maximum signal.

With regard to the first embodiment, it would be conceivable to provide an additional incremental sensor 170, for example an acceleration sensor. After detecting the direction to the transponder 200, at least changes in orientation of the reading device 100 are quantitatively detected with the aid of the incremental sensor 170, i.e. in particular, rotations about the vertical. In addition, changes in position could be also be detected. This data is supplied to the electronic assembly 130. There it is used, for example, to improve the result of the aforementioned estimate of the direction or for example, during or after a movement of the reading device 100 in the region, to verify or correct it.

Alternatively or in addition, with the aid of the preliminary data of the incremental sensor 170 or in the event that the transponder signal S is shielded by an obstacle and is therefore no longer being received, the direction to the transponder 200 already detected and displayed on the display device 120 can be corrected and re-displayed accordingly. If, for example, before a change in the orientation of the reading device, it was detected that the relative direction of the reading device 100 to the transponder 200 was at an angle of w=+30° to the longitudinal direction of the reading device, and if then, after no further transponder signal S was received, it was detected by the incremental sensor 170 that the orientation has changed by Δw+10°, then the electronic assembly 130 would calculate that the corrected relative direction w′ to the transponder 200 must now be at an angle of w′=w−Δw=+20° to the longitudinal direction of the reading device 100. Corresponding calculations could be made if the position of the reading device 100 changes.

The various assemblies of the reading device 100, i.e. the antenna device 110, the display 120, the pivoting device 140, the sensor 150, the electronic compass 160 and the optional incremental sensor 170, are all connected to the electronic assembly 130 (not shown).

In addition to determination of the direction, the distance from the reading device 100 to the transponder 200, for example, can also be estimated on the basis of the measured signal strength and displayed on the display device 120. The incremental sensor 170 can also be used to determine the distance between the reading device 100 and the transponder 200: the incremental sensor 170 determines the travel or a change in position of the reading device 100 while the signal strength of the transponder signal S is measured at the same time. This data is supplied to the electronic assembly 130. As the signal strength diminishes with the distance to the transponder 200, the direction in which the transponder 200 is located can be concluded from the characteristic of the signal strength. For example, with a decreasing signal strength it is to be assumed that one is moving away from the transponder 200 and vice versa. Based on the speed with which the measured signal strength changes, the direction can be estimated more precisely and not only, for example, whether one is moving away from the transponder 200: the transponder 200 is located in the direction in which the signal strength increases or decreases most rapidly. A beam antenna is not necessary for this.

The reading device and location method was described in connection with an active transponder. In principle, however, it is not absolutely essential that an active transponder is involved for functionality, i.e. in principle, passive transponders can also be used which, for example, receive or if necessary modulate and re-transmit a signal transmitted by the reading device.

The reading device can for example be designed to be in the nature of a PDA (“Personal Digital Assistant”).

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-13. (canceled)

14. A mobile reading device used with a transponder, comprising:
an antenna device receiving a signal transmitted by the transponder, the antenna device having a main radiation direction;
an electronic assembly calculating a direction from the reading device to the transponder using the signal;
a display device displaying the calculated direction; and
an orientation detector detecting at least one of orientation and a change in the orientation of the reading device with regard to a coordinate system assigned to an external region.

15. The mobile reading device as claimed in claim 14,
further comprising a signal strength detector detecting a signal strength of the signal received by the antenna device, and
wherein the electronic assembly calculates the direction to the transponder to be displayed on the display device from the signal strength of the signal received by the antenna device and the at least one of the orientation and the change in the orientation of the reading device detected simultaneously with detection of the signal strength.

16. The mobile reading device as claimed in claims 15, wherein the orientation detector detects an absolute orientation in the external region.

17. The mobile reading device as claimed in claim 16, further comprising an incremental sensor quantitatively detecting a change in the orientation of the reading device in the external region.

18. The mobile reading device as claimed in claim 15, wherein the orientation detector detects a relative orientation with regard to a particular initial situation of the reading device in the external region, in particular the change in the orientation compared with the initial situation.

19. The mobile reading device as claimed in claim 18, wherein a main radiation beam of the antenna device is pivotable in relation to the reading device.

20. The mobile reading device as claimed in claim 19, wherein the antenna device is pivotable in relation to the reading device.

21. The mobile reading device as claimed in claim 19, wherein the main radiation beam of the antenna device is pivotable electronically.

22. A method for detecting a direction from a mobile reading device to a transponder, the reading device having an antenna device with a main radiation direction, comprising:
receiving a signal from the transponder at the antenna device;
pivoting the main radiation direction, during said receiving, with regard to an external region;
detecting, concurrently with said pivoting, a strength of the signal and at least one of orientation and a change in the orientation of the reading device with regard to the external region;
correlating data sets including the signal strength measured during said pivoting and the at least one of the orientation and the change in the orientation detected concurrently; and
determining the direction to the transponder bared on the at least one of the orientation and the change in the orientation detected when a maximum signal strength is measured.

23. The method as claimed in claim 22, wherein said pivoting of the main radiation direction comprises at least one of
moving the reading device in relation to the external region,
moving the antenna device in relation to the reading device, and
using an electronic pivot.

24. The method as claimed in claim 23, wherein the transponder is a passive transponder and the signal received from the transponder is first transmitted by the reading device and reflected from the transponder.

25. The method as claimed in claim 23, wherein the transponder is an active transponder and transmits the signal actively.

26. The method as claimed in claim 25,
wherein said detecting detects an absolute orientation with regard to the external region, and
further comprising:
quantitatively detecting changes in the orientation of the reading device after the direction to the transponder has been determined; and
at least one of improving and correcting the direction based on the changes in the orientation of the reading device that are detected.
